(19) United States
(12) Patent Application Publication
(10) Pub. No.: US 2010/0212797 A1
(43) Pub. Date: Aug. 26, 2010

(54) Adjustable Foam Inserts for Vehicle Tires

(75) Inventor: James A. Eaton, Antelope, CA (US)

Correspondence Address: Hamilton DeSanctis & Cha, LLP, 3239 El Camino Real, Suite 220, Palo Alto, CA, 94306, US

(73) Assignee: Vanquish Products LLC

(21) Appl. No.: 12/712,063

(22) Filed: Feb. 24, 2010

Related U.S. Application Data
(60) Provisional application No. 61/154,937, filed on Feb. 24, 2009.

(51) Int. Cl. B60C 7/00; B29D 30/02

(52) U.S. Cl. 152/301; 152/246; 156/112

(57) ABSTRACT

The present application discloses a tire and wheel combination for a vehicle comprising a wheel comprising a rim; a tire comprising an annular side wall, an interior surface, wherein the tire is mounted on the rim; and a foam support insert comprising a compressible annular main body, wherein the annular main body comprises a central bore configured to received the wheel rim, and having an outer diameter that is greater than the inner diameter of the interior surface of the tire and being compressed and mounted inside the air cavity of the tire and circumferentially secured to the interior surface of the tire, wherein the foam support insert further comprises a first foam insert having a different foam density than the annular main body, and the foam insert is coupled to the main body and configured with regular or irregular geometric design; wherein the tire and wheel combination is not air tight sealed and filled with pressurized air, and vehicle comprising such combination.

### RELATED APPLICATION

This application claims the benefit of U.S. Provisional Application No. 61/154,937 filed Feb. 24, 2009, which is incorporated herein by reference.

### BACKGROUND OF THE INVENTION

The present disclosure relates generally to the field of inserts for vehicle tires, such as model vehicle tires and radio controlled (RC) model vehicle tires. More specifically, the disclosure relates to a foam insert for an RC vehicle. Such RC vehicles may be used for rock crawling.

Some RC vehicles are designed for rock crawling, requiring navigation over obstacles and extremely uneven, rocky surfaces. RC vehicles typically include an insert to maintain the shape of the tire instead of air pressure, as is generally used for larger vehicles. Because proper traction and tire behavior is so important to overcoming these obstacles, it is desirable to provide tire inserts for such an RC vehicle that allow the tire to be flexible enough to conform to the shape of the terrain to provide adequate traction while still being firm enough to provide enough support for the tires.

It would be desirable to provide an improved foam insert for RC model vehicles.

### SUMMARY OF THE INVENTION

One embodiment of the application relates to a tire and wheel combination for a vehicle comprising a wheel comprising a rim; a tire comprising an annular side wall, an interior surface, wherein the tire is mounted on the rim; and a foam support insert comprising a compressible annular main body, wherein the annular main body comprises a central bore configured to received the wheel rim, and having an outer diameter that is greater than the inner diameter of the interior surface of the tire and being compressed and mounted inside the air cavity of the tire and circumferentially secured to the interior surface of the tire, wherein the foam support insert further comprises a first foam insert having a different foam density than the annular main body, and the foam insert is coupled to the main body and configured with regular or irregular geometric design; wherein the tire and wheel combination is not air tight sealed and filled with pressurized air. In one aspect of the tire and wheel combination, the main body of the foam support insert comprises two or more layers of foam of different density. In one variation, the two or more layers of foam are concentric layers or coaxially arranged layers. In another variation, the two or more layers of foam are of the same width (or thickness) or of different width (or thickness). In another aspect of the tire and wheel combination, the main body comprises an inner layer of foam coupled together and sandwiched between at least two outer layers of foam, wherein the inner layer of foam has a different foam density than the outer layers of foam. In another aspect, the outer layers of foam have lower foam density than the inner layer of foam, or wherein the outer layers of foam have higher foam density than the inner layer of foam. In one variation of the above, the outer layers of foam comprise of a visco-elastic polyurethane foam, and the inner layer of foam comprises of conventional urethane foam. In another aspect of the combination, the main body comprises a plurality of openings arranged symmetrically or asymmetrically and coaxially with the foam support insert, and the openings configured to receive the first foam insert comprising a first set of multiple elongated foam inserts having higher density and stiffness than the main body. In another variation, the elongated foam inserts have generally oval, square or triangular cross-section profile. In another aspect, the above combination further comprises a second set of foam inserts on the outer periphery of the main body of the foam support insert, wherein the second set of foam inserts comprise of the same or different foam density than the first set of foam inserts.

In each of the above aspects and variations, the foam inserts comprise of a coaxial single integral body comprising multiple regular or irregular geometric protrusions, wherein the single integral body is coupled to the main body and forms the inner bore of the main body of the foam support insert. In a particular variation, the main body and the foam insert form two concentric shaped doughnut forms, with the main body forming an inner coaxial body and the support insert forming an outer coaxial body. In a particular variation, the single integral body comprises of a higher density foam than the foam of the main body. In another variation, the geometric protrusion(s) of the single integral body is a regular star shaped having at least two protrusions, or two star-shaped arms. In another variation, the geometric protrusions of the single integral body is a regular star shaped having at three, four, five, six, seven or at least eight protrusions. In a particular variation of each of the above, the foam density of the main body and the density of the foam insert is about 1.70 to about 15 lbs/cu. ft, and wherein the foam indentation force deflection (IFD) of the main body is about 6 to about 30 and the foam indentation force deflection (IFD) of the foam insert is about 18 to 45 and up. In a particular variation, the main body has a foam density of about 1.5 to 2.5 lbs/cu. ft and the IFD of about 6 to 24, and the foam insert has a foam density greater than about 2.5 to about 15 lbs/cu. ft. In a variation of each of the above, the main body and the foam inserts are made from open-cell foam, closed-cell foam, urethane foam, visco-elastic polyurethane foam, polymethacrylimide foam, polyvinylchloride foam, polypropylene foam, polyethylene foam, urethane foam, latex foam and combinations thereof. In another variation of each of the above, the wheel is formed from a rigid material selected from aluminum, brass, steel and hard plastics and combinations thereof.

In another embodiment, there is provided a foam support insert for inserting in a tire and wheel combination of a vehicle, wherein the foam support insert comprising a compressible annular main body, wherein the annular main body comprises a central bore configured to received the wheel rim, and having an outer diameter that is greater than the inner diameter of the interior surface of the tire and being compressed and mounted inside the air cavity of the tire and circumferentially secured to the interior surface of the tire, wherein the foam support insert further comprises a first foam insert having a different foam density than the annular main body, and the foam insert is coupled to the main body and configured with regular or irregular geometric design. In one variation of the above, the main body comprises a plurality of openings arranged symmetrically or asymmetrically and coaxially with the foam support insert, and the openings configured to receive the first foam insert comprising a first set of multiple elongated foam inserts having higher density and stiffness than the main body. In one aspect of the above, the elongated foam inserts have generally oval, square or triangular cross-section profile. In another aspect of the above, the foam support insert further comprises a second set of foam inserts on the outer periphery of the main body of the foam support insert, wherein the second set of foam inserts comprise of the same or different foam density than the first set of foam inserts. In a variation of each of the above, the foam inserts comprise of a coaxial single integral body comprising multiple regular or irregular geometric protrusions, wherein the single integral body is coupled to the main body and forms the inner bore of the main body of the foam support insert. In one variation of the above, the single integral body comprises of a higher density foam than the foam of the main body. In a particular variation, the geometric protrusion(s) of the single integral body is a regular star shaped having at least four protrusions. In another variation of the above, the foam density of the main body and the density of the foam inserts are about 1.70 to about 15 lbs/cu. ft. In another variation, the foam density of the main body is about 1.5 to 2.5 lbs/cu. ft, and the foam density of the foam insert is greater than about 2.5 to about 15 lbs/cu. ft.

In another embodiment, there is provided a method for maintaining the traction of a vehicle while driving of the vehicle in rough terrain, the method comprising equipping the vehicle with a tire and wheel combination comprising: a wheel comprising a rim; a tire comprising an annular side wall, an interior surface, wherein the tire is mounted on the rim; and a foam support insert comprising a compressible annular main body, wherein the annular main body comprises a central bore configured to received the wheel rim, and having an outer diameter that is greater than the inner diameter of the interior surface of the tire and being compressed and mounted inside the air cavity of the tire and circumferentially secured to the interior surface of the tire, wherein the foam support insert further comprises a first foam insert having a different foam density than the annular main body, and the foam insert is coupled to the main body and configured with regular or irregular geometric design; wherein the tire and wheel combination is not air tight sealed and filled with pressurized air. In one variation of the method, the vehicle is an RC vehicle.

### BRIEF DESCRIPTION OF THE DRAWINGS

These and other features, aspects, and advantages of the present invention will become apparent from the following description, appended claims, and the accompanying exemplary embodiments shown in the drawings, which are briefly described below.

FIG. 1 is an isometric view of a radio-controlled vehicle including tires with a foam insert according to an exemplary embodiment.

FIG. 2 is an exploded view of a tire assembly including a foam insert according to an exemplary embodiment.

FIG. 3 is a front view of a foam insert for a tire according to an exemplary embodiment.

FIG. 4 is an exploded view of the foam insert of FIG. 3.

FIG. 5 is an isometric view of a foam insert for a tire including a second set of inserts according to another exemplary embodiment.

FIG. 6 is a partially exploded view of the foam insert of FIG. 5.

FIG. 7 is an isometric view of a foam insert for a tire including a second set of inserts according to another exemplary embodiment.

FIG. 8 is a partially exploded view of the foam insert of FIG. 7.

### DETAILED DESCRIPTION OF THE PREFERRED EMBODIMENTS

The invention is described in more detail hereinafter with reference to exemplary embodiments. In the figures, for the sake of clarity, the same reference numerals are used for similar components in different embodiments.

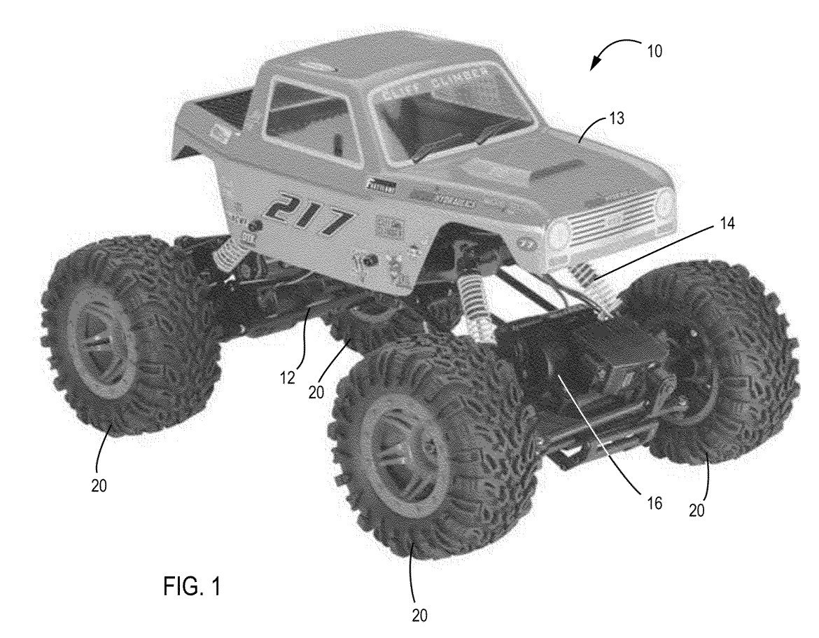

Referring to FIG. 1, a radio controlled model vehicle 10 is shown according to an exemplary embodiment. The vehicle 10 is configured to be controlled via radio waves from a handheld controller. The vehicle 10 preferably comprises a substantially chassis or frame 12. An aerodynamically shaped shell or body 13. The body 13 may include a multitude of vehicular detailing. The detailing may be three dimensional merely surface ornamentation or indicia. Such detailing may be functional or may simply simulate similar functional elements on larger vehicles.

The frame 12 is coupled to a multitude of wheels 20 (generally four) with a suspension 14. According to a one embodiment, each of the wheels 20 has a suspension 14. One or more motors 16 provide power to the vehicle 10 and turn the wheels 20. Each wheel 20 or pair of wheels 20 (e.g., the pair of front wheels and the pair of rear wheels) may also be coupled to a steering assembly 18. By providing the wheels 20 for the vehicle 10 with a suspension 14 and or steering assembly 18, the vehicle 10 is better able to maneuver the wheels 20 and traverse over relatively rough terrain.

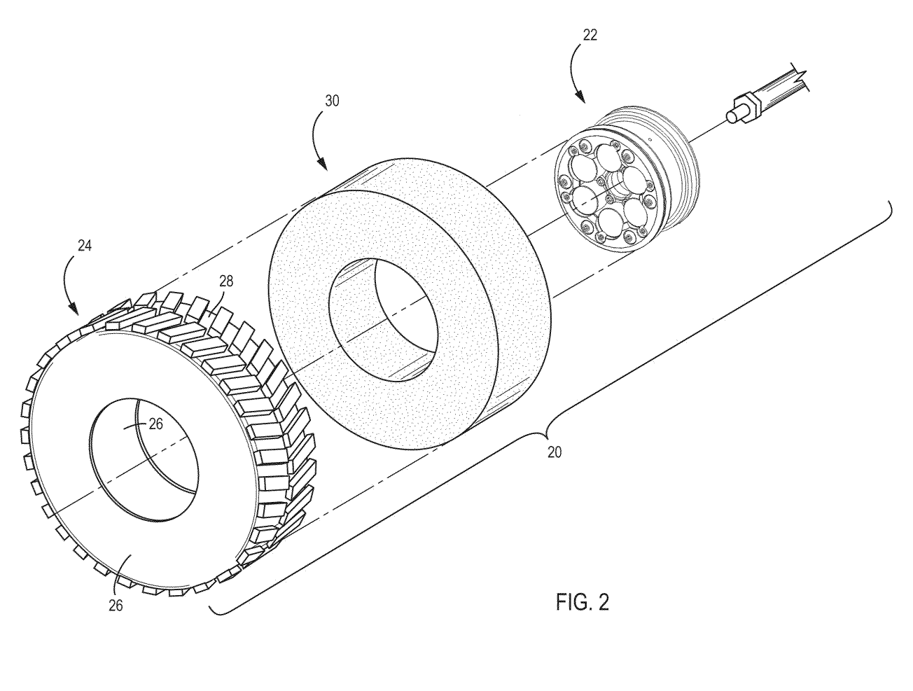

Referring now to FIG. 2, a wheel 20 for an RC vehicle 10 is shown according to an exemplary embodiment. The wheel 20 comprises a rim 22 that receives a tire 24. The rim 22 is formed from a relatively rigid material such as a metal (e.g., aluminum, brass, steel, etc.) or a polymer (e.g., nylon). The wheel 20 is coupled to the axle that is driven by the motor 16. The tire 24 is formed from a resilient material such as rubber and is coupled to the rim 22. According to various exemplary embodiments, the tire 24 may be affixed to the rim 22 with an adhesive, with a mechanical connection (e.g., by being trapped between two portions of the rim), or any other suitable fastening method known in the art.

The tire 24 includes annular side walls 26 that are coupled to the rim 22 and a tread portion 28 that extends around the periphery of the tire 24 and contacts the surface upon which the vehicle 10 is driven. The tire 24 is configured to flex and deform so that the tread 28 can better conform to the surface upon which the vehicle 10 is driven. However, unlike tires on larger vehicles, the tires 24 on most RC model vehicles 10 are not filled with pressurized air. Instead, a foam support insert 30 is provided within the tire 24, between the tire 24 and the rim 22. The foam support insert 30 is a compressible body that allows the tire to deform 24 but prevents excessive deformation such as “bottoming out” such that the rim 22 may come within close proximity of contacting the driving surface. According to one embodiment, the foam support insert 30 is formed from a closed-cell foam such as a urethane foam. While the circumferential wall is referred to in this disclosure as the tread or tread portion 28, it should be understood that the raised tread pattern of the vehicle wheel 20 may extend around the surface of the wheel onto the sidewalls 26 as well.

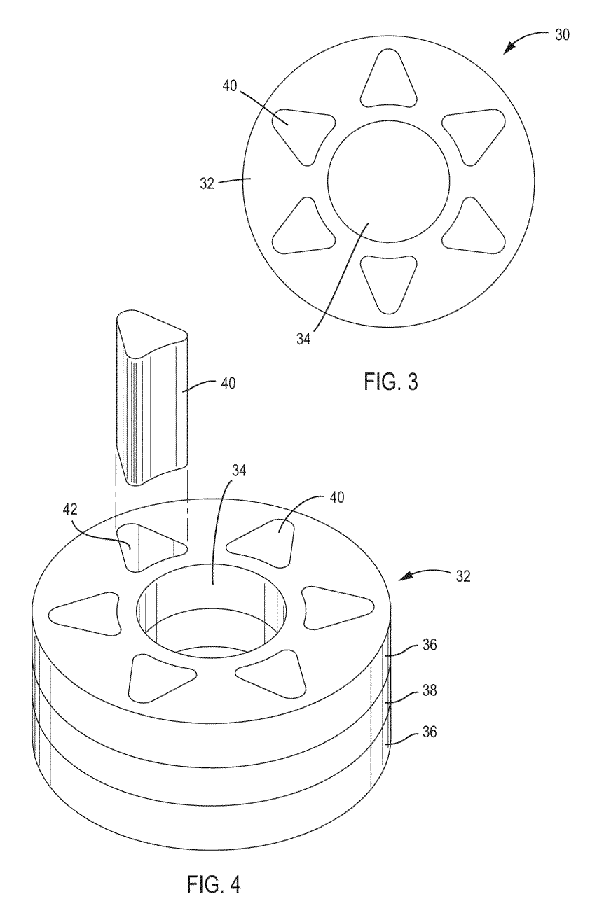

Referring now to FIGS. 3-4, a foam support insert 30 is shown according to an exemplary embodiment. The foam support insert 30 includes a main body 32 and one or more elongated inserts 40. The main body 32 is an annular body (e.g., donut-shaped, ring-shaped, etc.) that includes a central bore 34 that is configured to receive the wheel rim 22. The foam support insert 30 may have an outer diameter that is less than the diameter of the tread portion 28 of the tire 24 such that there is a gap between the foam support insert 30 and the tread portion 28. According to another exemplary embodiment, the foam support insert 30 may have an outer diameter that is equal to or even greater than the diameter of the tread portion 28 of the tire 24. As such, the foam support insert 30 may be compressed when it is inserted between the rim 22 and the tire 24. Compressing the foam support insert 30 within the tire 24 induces a pre-load such that the foam exerts a constant force outward on the tire 24.

The main body 32 may comprise two or more layers or laminae. As shown in FIGS. 3-8, in a preferred embodiment, the main body 32 comprises two outer layers 36 and an inner layer 38. The outer layers 36 and the inner layer 38 may be approximately the same thickness or may have different thicknesses. The outer layers 36 may have a different stiffness and different density than the inner layer 38 or the outer layers 36 may have different stiffness and different density compared to each other. For example, the outer layers 36 may be formed from a relatively stiff foam to support the sides of the tread portion 28 and the side walls 26, while the inner layer 38 may be formed from a relatively soft foam. In a preferred embodiment, the outer layers 36 are formed of a visco-elastic polyurethane foam, commonly known as a “memory foam”, while the inner layer 38 is formed from a stiffer conventional urethane foam. Memory foam allows the tire 24 to flex more over obstacles and rough terrain does not expand back to its original shape as quickly as conventional urethane foam. This reduces the likelihood that the vehicle 10 will bounce or hop when crossing rough terrain.

According to various exemplary embodiments, the layers 36 and 38 may be coupled together with a wide variety of suitable fastening methods such as adhesives, hook and loop fasteners, or mechanical fasteners, or the like. While FIGS. 3-8 illustrate a foam support insert having a main body with only three layers, it should be understood that, according to other exemplary embodiments, the foam support may have more or fewer layers. For example, the main body may have 2, 3, 4, 5, 6 or more layers of foam, wherein the different layers of foam may have the same or different foam density.

A plurality of through openings 42 (e.g., holes, apertures, cavities, etc.) are provided in the main body 32 that are configured to receive corresponding inserts 40. The inserts 40 extend laterally, through the layers 36 and 38 and allow a user to selectively alter the compression behavior of the foam support insert 30 (e.g., to allow the vehicle 10 to traverse various terrains). According to a preferred embodiment, the inserts 40 are relatively dense and stiff compared to the main body 32. The inserts 40 create localized areas of stiffness in the foam support insert 30. Therefore, when the vehicle is traversing a rough or uneven surface, such as when the tire is in contact with a rock or a boulder, for example, the portions of the tread portion 28 of the tire 24 radially aligned with the inserts 40 do not compress toward the rim 22 as much as the intermediate portions. The uneven compression distorts the tread portion 28 and helps the tire 24 better grip the driving surface and propel the vehicle 10, maintaining traction and allowing the vehicle to continue traversing over the terrain.

By combining a relatively stiff insert 40 with a relatively soft main body 32, advantages from both types of foam are realized. The inserts 40 provide a support for the tire 24 in both a radial direction (e.g., from the rim 22 out to the tread portion 28) and in an axial direction (e.g., by pushing against the side walls 26). The soft main body 32 on the other hand absorbs shock and reduces the effect of any “bounce” from the stiff inserts 40.

As shown in FIGS. 3-4, according to one exemplary embodiment, the inserts 40 have a generally triangular cross-section profile. The inserts 40 are arranged symmetrically about the inner bore 34 of the main body 32, oriented to form outwardly-facing wedges. The wedge shape of the triangular inserts 40 effectively resists compression from a radial force directed inward (e.g., from the driving surface due to the weight of the vehicle 10).

According to one exemplary embodiment, the openings 42 in the main body 32 are formed with a die-cutting operation. The original material occupying the openings (e.g., the removed portions of the outer layers 36 and inner layer 38) may not be disposed of and may instead be provided to the user along with the inserts 40. In this way, the user may customize the foam support insert 30 by inserting into the openings 42 the original material, the inserts 40 or even nothing at all. For instance, a user may only use inserts 40 in some of the openings 42 while using the original material 42 in other openings 42.

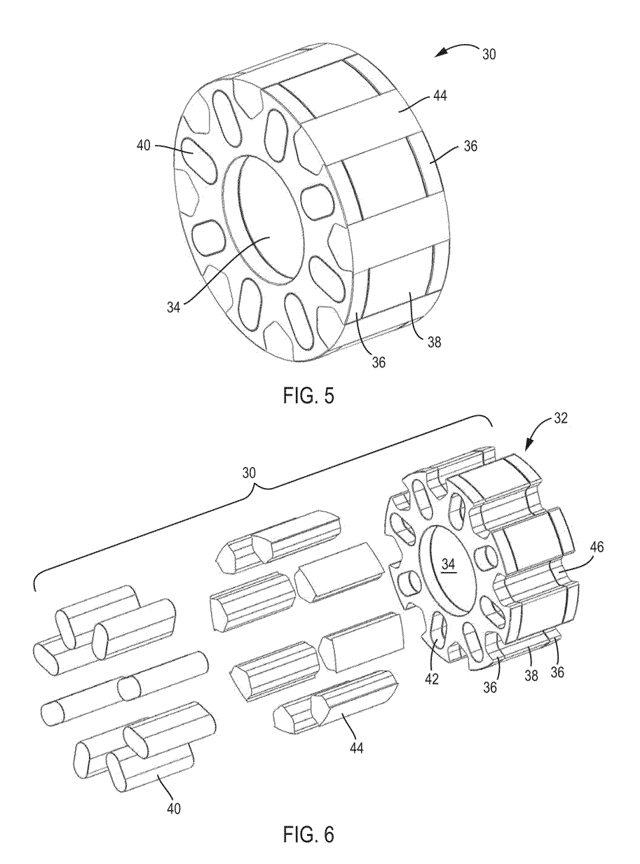

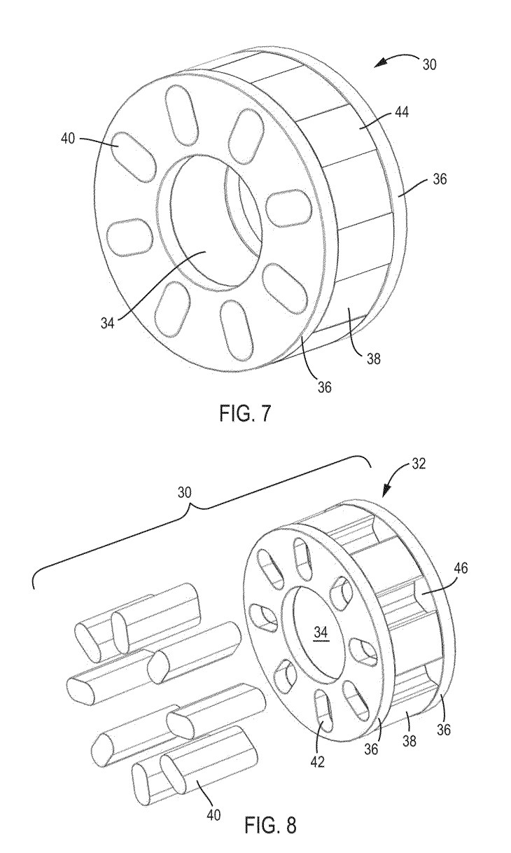

While the foam support insert 30 of FIGS. 3-4 is shown comprising six equally spaced triangular inserts 40 and corresponding openings 42, it should be understood that a number of variations are possible. For instance, as shown in FIGS. 5-8, the inserts 40 and openings 42 may be generally pill-shaped. A greater or fewer number of inserts 40 and openings 42 may be provided. For instance, the foam support insert 30 may include eight inserts 40 and openings 42 as shown in FIGS. 5-8. According to still other exemplary embodiments, the inserts may not be equally spaced and may instead be provided in groups spaced around the main body 32. The openings 42 may be located such that they are surrounded by the main body 32, may extend inward from the outer periphery of the main body (as shown in regards to openings 46 in FIG. 6), or may extend outward from the inner bore 34.

Referring now especially to FIGS. 5-6, according to still other exemplary embodiments, a foam support insert 30 may include a first set of inserts 40 and openings 42, and a second group of inserts 44 that are received in a second group of openings 46. The second inserts 44 may be formed of the same material as the first inserts 44 or may be a different material.

According to a preferred embodiment, the second inserts 44 have a generally pentagonal cross-section profile. The second inserts 44 are received in corresponding openings 46 (e.g., grooves, hollows, cut-outs, etc.) provided about the periphery of the main body 32. The second inserts 44 are generally offset from the first inserts 40. By placing the second inserts 46 closer to the periphery of the main body 32 and, therefore, closer to the tread portion 28 of the tire 24. The second inserts 46 then effect the deformation of the tire 24 differently than the first inserts 40 as the vehicle 10 traverses the uneven terrain.

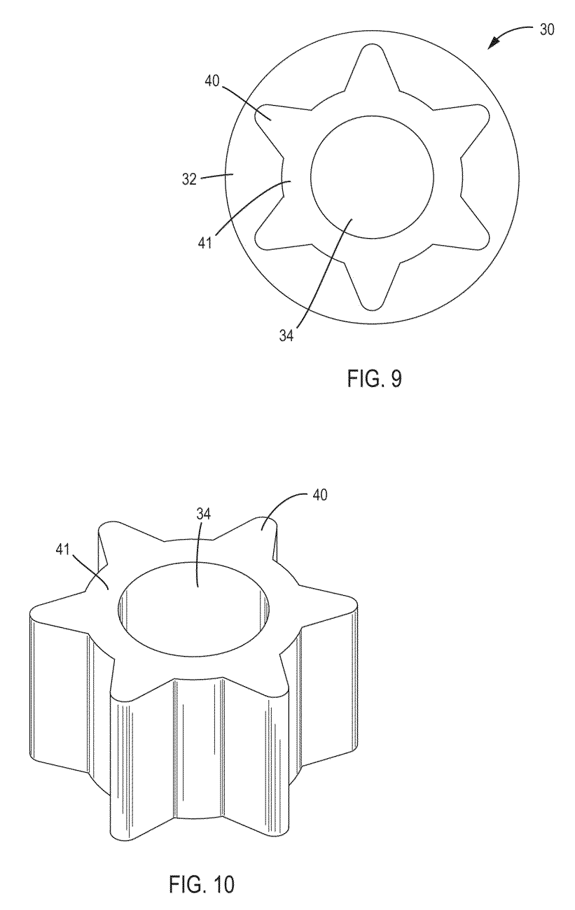

Referring now to FIGS. 7-8, according to still another exemplary embodiment, a foam support insert 30 may include a first set of inserts 40 and openings 42 similar to those shown in FIGS. 5-6, and a second set of openings 48. The second openings 48 are similar to the openings 46 shown in FIGS. 5-6, but do not extend through all the layers of the main body 32. Instead, the openings 48 are provided only in the middle layer 38. According to other exemplary embodiments, openings may be provided in only the outer layers 36 and not the middle layer 34. Such an incomplete opening 48 may receive a similarly shortened insert or may be left open, as shown in FIGS. 7-8.

Similarly, the openings 42 for the inserts 40 may only extend part of the way through the main body 32. For instance, openings 42 may only extend through one of the outer layers 36 and the middle layer 38 and not through the opposite outer layer 36. The inserts 40 received in the shortened openings 42 would likewise be shorter than the overall depth of the main body 32. Such a shortened insert 40 may be desirable, for example, to encourage a different deformation near the outside sidewall 26 of the tire 24 or the inside sidewall 26.

Referring now to FIGS. 9-10, according to yet another exemplary embodiment, the inserts 40 may be formed as a single integral body, joined together by a ring 41. In a preferred embodiment, the ring 41 forms the inner bore 34 as shown in FIGS. 9 and 10 and receives the rim 22.

By forming the inserts 40 as a single body, the assembly of the foam support insert 30 is made easier. Instead of fitting multiple inserts 40 into multiple openings 42, the single body can be easily nested within the main body 32. Further, the ring 41 helps to support the inserts 40 and reduces the likelihood that they will flex or twist relative to the main body 32. Still further, the ring 41 supports the inserts 40 such that can better resist a radial force (e.g., compression from the tire 24), therefore creating a larger difference between the stiffness of the areas of the foam support insert 30 proximate to the inserts 40 and the stiffness of the main body 32 between the inserts 40.

According to other exemplary embodiments, an additional laminate piece, similar to main body 32, or an additional solid foam piece may form another concentric body within the ring 41 to form the bore 34. The ring 41 may also be formed on the outside edge of the inserts 40 and lie proximate to the inside surface of the tread portion 28 of the tire 24.

As used herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

It should be noted that the term “exemplary” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

The term “foam support insert” is used herein to refers to the insert having a main body 30 that may be inserted and mounted inside the air cavity of a tire. The term “insert” or “foam insert” refers to the insert such as the foam inserts 40 that comprises a part of the “foam support insert” and may be inserted into the main body of “foam support insert.” The “insert” or “foam insert” has a different foam density than the “foam support insert.” In a preferred aspect, the foam insert has a higher density than the foam support insert and is more resilient and stiffer than the foam support insert.

The term “indentation for deflection” or “IFD” is defined according to the Joint Industry Standards and Guidelines for foams as the amount of force, in pounds, required to indent a fifty square inch, round indentor foot into a predefined foam specimen a certain percentage of the specimen's total thickness. The IFD measures the firmness of the foam based on a physical property, the IFD. Typically, the IFD at 25% deflection use (pounds/50 insq. on 20″×20″×4″) ranges about 6 to about 45 and higher.

References herein to the positions of elements (e.g., “top,” “bottom,” “above,” “below,” etc.) are merely used to describe the orientation of various elements in the accompanying drawings. It should be noted that the orientation of various elements may differ according to other exemplary embodiments, and that such variations are intended to be encompassed by the present disclosure.

It is important to note that the construction and arrangement of the foam inserts as shown in the various exemplary embodiments is illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. For example, elements shown as integrally formed may be constructed of multiple parts or elements, the position of elements may be reversed or otherwise varied, and the nature or number of discrete elements or positions may be altered or varied. The order or sequence of any process or method steps may be varied or re-sequenced according to alternative embodiments. Other substitutions, modifications, changes and omissions may also be made in the design, operating conditions and arrangement of the various exemplary embodiments without departing from the scope of the present invention.

What is claimed is:

1. A tire and wheel combination for a vehicle comprising:
a wheel comprising a rim;
a tire comprising an annular side wall, an interior surface, wherein the tire is mounted on the rim; and
a foam support insert comprising a compressible annular main body, wherein the annular main body comprises a central bore configured to received the wheel rim, and having an outer diameter that is greater than the inner diameter of the interior surface of the tire and being compressed and mounted inside the air cavity of the tire and circumferentially secured to the interior surface of the tire, wherein the foam support insert further comprises a first foam insert having a different foam density than the annular main body, and the foam insert is coupled to the main body and configured with regular or irregular geometric design;
wherein the tire and wheel combination is not air tight sealed and filled with pressurized air.

2. The tire and wheel combination of claim 1, wherein the main body of the foam support insert comprises two or more layers of foam of different density.

3. The tire and wheel combination of claim 2, wherein the main body comprises an inner layer of foam coupled together and sandwiched between at least two outer layers of foam, wherein the inner layer of foam has a different foam density than the outer layers of foam.

4. The tire and wheel combination of claim 3, wherein the outer layers of foam have lower foam density than the inner layer of foam, or wherein the outer layers of foam have higher foam density than the inner layer of foam.

5. The tire and wheel combination of claim 3, wherein the outer layers of foam comprise of a visco-elastic polyurethane foam, and the inner layer of foam comprises of conventional urethane foam.

6. The tire and wheel combination of claim 1, wherein the main body comprises a plurality of openings arranged symmetrically or asymmetrically and coaxially with the foam support insert, and the openings configured to receive the first foam insert comprising a first set of multiple elongated foam inserts having higher density and stiffness than the main body.

7. The tire and wheel combination of claim 6, wherein the elongated foam inserts have generally oval, square or triangular cross-section profile.

8. The tire and wheel combination of claim 6, further comprising a second set of foam inserts on the outer periphery of the main body of the foam support insert, wherein the second set of foam inserts comprise of the same or different foam density than the first set of foam inserts.

9. The tire and wheel combination of claim 1, wherein the foam inserts comprise of a coaxial single integral body comprising multiple regular or irregular geometric protrusions, wherein the single integral body is coupled to the main body and forms the inner bore of the main body of the foam support insert.

10. The tire and wheel combination of claim 9, wherein the single integral body comprises of a higher density foam than the foam of the main body.

11. The tire and wheel combination of claim 1, wherein the foam density of the main body and the density of the foam insert is about 1.70 to about 15 lbs/cu. ft, and wherein the foam indentation force deflection of the main body is about 6 to about 30 and the foam indentation force deflection of the foam insert is about 18 to 45 and up.

12. The tire and wheel combination of claim 1, wherein the main body and the foam inserts are made from open-cell foam, closed-cell foam, urethane foam, visco-elastic polyurethane foam, polymethacrylimide foam, polyvinylchloride foam, polypropylene foam, polyethylene foam, urethane foam, latex foam and combinations thereof.

13. A foam support insert for inserting in a tire and wheel combination of a vehicle, wherein the foam support insert comprising a compressible annular main body, wherein the annular main body comprises a central bore configured to received the wheel rim, and having an outer diameter that is greater than the inner diameter of the interior surface of the tire and being compressed and mounted inside the air cavity of the tire and circumferentially secured to the interior surface of the tire, wherein the foam support insert further comprises a first foam insert having a different foam density than the annular main body, and the foam insert is coupled to the main body and configured with regular or irregular geometric design.

14. The foam support insert of claim 13, wherein the main body comprises a plurality of openings arranged symmetrically or asymmetrically and coaxially with the foam support insert, and the openings configured to receive the first foam insert comprising a first set of multiple elongated foam inserts having higher density and stiffness than the main body.

15. The foam support insert of claim 14, wherein the elongated foam inserts have generally oval, square or triangular cross-section profile.

16. The foam support insert of claim 14, further comprising a second set of foam inserts on the outer periphery of the main body of the foam support insert, wherein the second set of foam inserts comprise of the same or different foam density than the first set of foam inserts.

17. The foam support insert of claim 13, wherein the foam inserts comprise of a coaxial single integral body comprising multiple regular or irregular geometric protrusions, wherein the single integral body is coupled to the main body and forms the inner bore of the main body of the foam support insert.

18. The foam support insert of claim 17, wherein the single integral body comprises of a higher density foam than the foam of the main body.

19. A method for maintaining the traction of a vehicle while driving of the vehicle in rough terrain, the method comprising equipping the vehicle with a tire and wheel combination comprising:
a wheel comprising a rim;
a tire comprising an annular side wall, an interior surface, wherein the tire is mounted on the rim; and
a foam support insert comprising a compressible annular main body, wherein the annular main body comprises a central bore configured to received the wheel rim, and having an outer diameter that is greater than the inner diameter of the interior surface of the tire and being compressed and mounted inside the air cavity of the tire and circumferentially secured to the interior surface of the tire, wherein the foam support insert further comprises a first foam insert having a different foam density than the annular main body, and the foam insert is coupled to the main body and configured with regular or irregular geometric design;
wherein the tire and wheel combination is not air tight sealed and filled with pressurized air.

20. The method of claim 19, wherein the vehicle is an RC vehicle.
